(19) United States
(12) Patent Application Publication
(10) Pub. No.: US 2026/0000045 A1
(43) Pub. Date: Jan. 1, 2026

(54) Horse Pen Bar System and Method of Use

(71) Applicants: Ferlin Albert Darnell, Amarillo, TX (US); Janelle Reetz, Amarillo, TX (US)

(72) Inventors: Ferlin Albert Darnell, Amarillo, TX (US); Janelle Reetz, Amarillo, TX (US)

(21) Appl. No.: 19/013,819

(22) Filed: Jan. 8, 2025

Related U.S. Application Data
(60) Provisional application No. 63/665,053, filed on Jun. 27, 2024.

(51) Int. Cl. A01K 1/00

(52) U.S. Cl. CPC A01K 1/0005

(57) ABSTRACT

A horse pen bar system, configured for installation within an entrance of a horse pen for containing a horse and improving the psychological well-being of the horse. Wherein: the horse pen bar system comprises a main support bar and two threaded assemblies. The main support bar extends longitudinally between the two threaded assemblies. The two threaded assemblies comprises a first threaded assembly and a second threaded assembly. The two threaded assemblies are positioned at opposing ends of main support bar. Each of the two threaded assemblies includes a threaded shaft and an engagement element. The entrance defines the open area between two vertical supports. The two vertical supports comprise a first vertical support and a second vertical support, positioned on opposing sides of the entrance. The threaded shaft enables length adjustment through rotational movement, allowing the horse pen bar system to fit securely within the entrance.

### CROSS-REFERENCE TO RELATED APPLICATIONS

This application claims benefit to U.S. provisional application 63/665,053 filed 2024-06-27.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

Horses are typically housed in pens or stalls for safety and convenience. However, conventional stall designs can create significant psychological and physical challenges for horses. Many stalls, often as small as 10 feet by 10 feet, isolate horses from their surroundings and other horses. This isolation can lead to feelings of claustrophobia and stress, as horses are social animals that prefer to see and interact with their environment.

Existing pen or stall systems often include panel systems comprising multiple horizontal and vertical bars. These systems, while functional, present issues of bulkiness and limited portability, making them difficult to store and transport. Furthermore, prior art designs, such as mesh gates, pose safety risks due to sharp edges and gaps that can trap a horse's legs or other body parts, potentially causing injury.

The installation methods for these conventional systems are also limited. Many designs rely on hooks or ropes to secure the panels in place. This configuration can be unreliable, allowing the panels to be easily dislodged if a horse applies pressure. Additionally, these systems cannot be effectively secured to solid walls, further limiting their versatility.

To address these challenges, the present invention introduces a more versatile and secure horse pen bar system that is compact, portable, and safe. The system is designed with rounded edges to prevent harm to the horse, while offering the flexibility to be installed in various settings, including solid walls. Moreover, the system provides a more open environment, allowing horses to see down hallways and observe people and other horses, thereby addressing psychological needs.

The present invention also improves upon traditional materials and coatings. The system transitions from using Schedule 40 pipe to lighter 14-gauge tubing, enhancing portability without compromising durability. Additionally, the system incorporates a painted finish with plans to move to powder coating for improved longevity and resistance to wear. The threading is designed to be lubricated for reducing dirt accumulation and ensuring smooth operation. This lubrication can be achieved using a lubricant containing molybdenum disulfide, which reduces friction and resists dirt accumulation.

This novel system offers a practical and safe solution to the limitations of prior art while addressing both the psychological and physical well-being of horses.

No prior art is known to the Applicant.

### BRIEF SUMMARY OF THE INVENTION

A horse pen bar system 100, configured for installation within an entrance 206 of a horse pen 200 for containing a horse 400 and improving the psychological well-being of the horse 400. Wherein: said horse pen bar system 100 comprises a main support bar 102 and two threaded assemblies 104. Said main support bar 102 extends longitudinally between said two threaded assemblies 104. Said two threaded assemblies 104 comprises a first threaded assembly 104a and a second threaded assembly 104b. Said two threaded assemblies 104 are positioned at opposing ends of main support bar 102. Each of said two threaded assemblies 104 includes a threaded shaft 106 and an engagement element 112. Said entrance 206 defines the open area between two vertical supports 204. Said two vertical supports 204 comprise a first vertical support 204a and a second vertical support 204b, positioned on opposing sides of said entrance 206. Said threaded shaft 106 enables length adjustment through rotational movement, allowing the horse pen bar system 100 to fit securely within said entrance 206. Said two threaded assemblies 104 each comprise the threaded shaft 106 featuring a first threading orientation 700a and a second threading orientation 700b. Said first threading orientation 700a and said second threading orientation 700b are opposite one another. These opposing threading orientations allow for simultaneous expansion or contraction of said horse pen bar system 100, ensuring secure and precise adjustments between mounting points. At either end of said main support bar 102, a first internal threaded receptacle 702a and a second internal threaded receptacle 702b are integrated. Said first internal threaded receptacle 702a comprises threading matching said first threading orientation 700a of said first threaded assembly 104a. Said second internal threaded receptacle 702b comprises threading matching said second threading orientation 700b of said second threaded assembly 104b. By rotating main support bar 102 while holding a portion of two threaded assemblies 104 secure, said two threaded assemblies 104 will extend into or out of main support bar 102 causing a system width 1100 of horse pen bar system 100 to transition between an extended configuration 1100a and a contracted configuration 1100b.

The horse pen bar system 100, configured for installation within the entrance 206 of the horse pen 200 for containing the horse 400 and improving the psychological well-being of the horse 400. Wherein: said horse pen bar system 100 comprises the main support bar 102 and two threaded assemblies 104. Said main support bar 102 extends longitudinally between said two threaded assemblies 104. Said two threaded assemblies 104 comprises the first threaded assembly 104a and the second threaded assembly 104b. Said two threaded assemblies 104 are positioned at opposing ends of main support bar 102. Each of said two threaded assemblies 104 includes the threaded shaft 106 and the engagement element 112. Said entrance 206 defines the open area between two vertical supports 204. Said two vertical supports 204 comprise the first vertical support 204a and the second vertical support 204b, positioned on opposing sides of said entrance 206. Said threaded shaft 106 enables length adjustment through rotational movement, allowing the horse pen bar system 100 to fit securely within said entrance 206. Said two threaded assemblies 104 each comprise the threaded shaft 106 featuring the first threading orientation 700a and the second threading orientation 700b. Said first threading orientation 700a and said second threading orientation 700b are opposite one another. These opposing threading orientations allow for simultaneous expansion or contraction of said horse pen bar system 100, ensuring secure and precise adjustments between mounting points. At either end of said main support bar 102, the first internal threaded receptacle 702a and the second internal threaded receptacle 702b are integrated. Said first internal threaded receptacle 702a comprises threading matching said first threading orientation 700a of said first threaded assembly 104a. Said second internal threaded receptacle 702b comprises threading matching said second threading orientation 700b of said second threaded assembly 104b. By rotating main support bar 102 while holding a portion of two threaded assemblies 104 secure, said two threaded assemblies 104 will extend into or out of main support bar 102 causing the system width 1100 of horse pen bar system 100 to transition between the extended configuration 1100a and the contracted configuration 1100b. Said main support bar 102 comprises rounded edges and smooth finishes to minimize injury risks to horses during use, particularly in environments where horses may apply pressure to or rub against the horse pen bar system 100. Said main support bar 102 comprises a tube interior 1000 and a tube body 1002. Said two threaded assemblies 104 are configured to rotateably enter and exit said tube interior 1000 by rotating either said main support bar 102 or said threaded shaft 106.

The horse pen bar system 100, configured for installation within the entrance 206 of the horse pen 200 for containing the horse 400 and improving the psychological well-being of the horse 400. Wherein: said horse pen bar system 100 comprises the main support bar 102 and two threaded assemblies 104. Said main support bar 102 extends longitudinally between said two threaded assemblies 104. Said two threaded assemblies 104 comprises the first threaded assembly 104a and the second threaded assembly 104b. Said two threaded assemblies 104 are positioned at opposing ends of main support bar 102. Each of said two threaded assemblies 104 includes the threaded shaft 106 and the engagement element 112. Said entrance 206 defines the open area between two vertical supports 204. Said two vertical supports 204 comprise the first vertical support 204a and the second vertical support 204b, positioned on opposing sides of said entrance 206. Said threaded shaft 106 enables length adjustment through rotational movement, allowing the horse pen bar system 100 to fit securely within said entrance 206. Said two threaded assemblies 104 each comprise the threaded shaft 106 featuring the first threading orientation 700a and the second threading orientation 700b. Said first threading orientation 700a and said second threading orientation 700b are opposite one another. These opposing threading orientations allow for simultaneous expansion or contraction of said horse pen bar system 100, ensuring secure and precise adjustments between mounting points. At either end of said main support bar 102, the first internal threaded receptacle 702a and the second internal threaded receptacle 702b are integrated. Said first internal threaded receptacle 702a comprises threading matching said first threading orientation 700a of said first threaded assembly 104a. Said second internal threaded receptacle 702b comprises threading matching said second threading orientation 700b of said second threaded assembly 104b. By rotating main support bar 102 while holding a portion of two threaded assemblies 104 secure, said two threaded assemblies 104 will extend into or out of main support bar 102 causing the system width 1100 of horse pen bar system 100 to transition between the extended configuration 1100a and the contracted configuration 1100b. Each of said two threaded assemblies 104 includes the threaded shaft 106 and a swivel flange nut 108. Said swivel flange nut 108 comprises a base portion 1006 and a socket portion 1008. Said swivel flange nut 108 is configured to rotate relative to threaded shaft 106 by securing engagement element 112 to socket portion 1008, securing a portion of said threaded shaft 106 to base portion 1006, and allowing base portion 1006 and socket portion 1008 to rotate relative to one another.

### BRIEF DESCRIPTION OF THE SEVERAL VIEWS OF THE DRAWING

FIG. 1 illustrates a perspective view of a horse pen bar system 100, configured for installation within a horse pen or stall to provide structural reinforcement and enhanced safety.

FIG. 2 illustrates a perspective view of a horse pen 200, including an entrance 206, an enclosed space 208, and the installed horse pen bar system 100.

FIG. 3 introduces a detailed view of the structural relationship between the components of said horse pen bar system 100 and the surrounding environment, offering additional clarity on its installed configuration.

FIG. 4 illustrates a perspective view of the horse pen bar system 100 in use within the horse pen 200, highlighting the interaction between said horse pen bar system 100 and a horse 400.

FIG. 5 illustrates an alternate perspective of said horse pen 200, focusing on the placement of said horse pen bar system 100 relative to its installed environment.

FIGS. 6A and 6B provide an elevated top view and a side view, respectively, of said horse pen bar system 100.

FIG. 7 provides a detailed view of the threading configurations of said horse pen bar system 100, including a first threaded assembly 104a and a second threaded assembly 104b.

FIGS. 8A and 8B illustrate two elevated top views of said horse pen bar system 100 with two configurations of an engagement element 112.

FIG. 9 illustrates a cross-section perspective overview of horse pen bar system 100.

FIG. 10 illustrates a cross-section elevated front view of horse pen bar system 100.

FIGS. 11A and 11B illustrate two cross-section elevated front views of horse pen bar system 100 in an extended configuration 1100a and a contracted configuration 1100b.

FIG. 12 illustrates a perspective overview of horse pen bar system 100 with a torque tool 1200.

FIGS. 13A and 13B illustrate said horse pen bar system 100 interacting with a round post 1300a and a square post 1300b.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

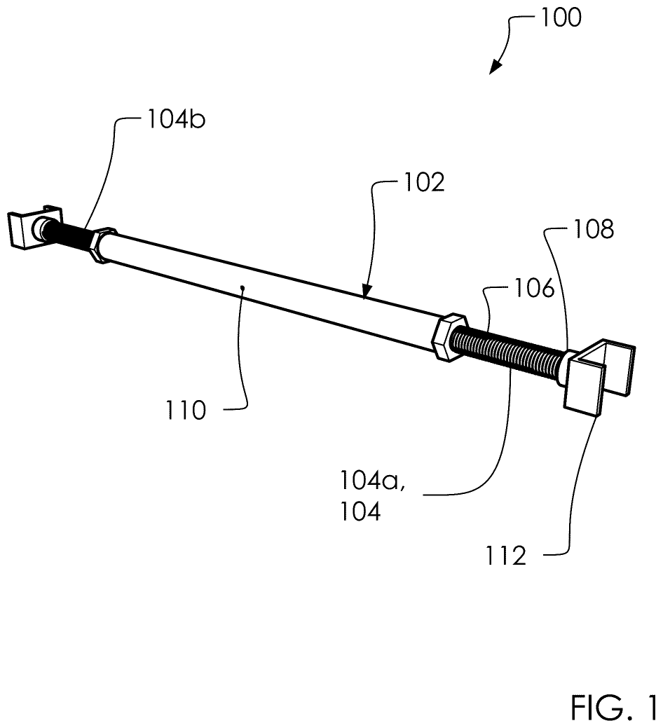

FIG. 1 illustrates a perspective view of a horse pen bar system 100, configured for installation within a horse pen or stall to provide structural reinforcement and enhanced safety.

Said horse pen bar system 100 can be configured as an adjustable, compact, and portable system, allowing for secure installation in various environments.

In one embodiment, said horse pen bar system 100 comprises a main support bar 102, which extends longitudinally and connects two threaded assemblies 104 positioned at opposing ends. Said main support bar 102 can be tubular and fabricated from 14-gauge tubing, offering a lightweight yet durable structure suitable for repeated use and portability.

Said two threaded assemblies 104 can comprise a first threaded assembly 104a and a second threaded assembly 104b. Said first threaded assembly 104a and said second threaded assembly 104b are positioned at opposing ends of said main support bar 102, collectively facilitating secure installation of said horse pen bar system 100 against structural surfaces.

Each of said two threaded assemblies 104 includes a threaded shaft 106 and a swivel flange nut 108. Said threaded shaft 106 enables length adjustment through rotational movement, allowing said horse pen bar system 100 to fit securely between solid walls or other fixed structures.

In one embodiment, said swivel flange nut 108 is designed to securely engage with said threaded shaft 106, offering stability while accommodating slight angular misalignments during installation.

In the embodiment shown, said main support bar 102 further comprises a centrally positioned torque aperture 110. Said torque aperture 110 is configured to receive a torque tool 1200 (illustrated below), such as a pipe or screwdriver, enabling the user to apply additional leverage when twisting said main support bar 102. This added torque facilitates secure and precise adjustments of the horse pen bar system 100, ensuring a snug fit between structural surfaces. This added torque ensures a tight and stable installation, even in high-stress environments.

The design incorporates rounded edges and smooth finishes to minimize injury risks to horses during use, particularly in environments where horses may apply pressure to or rub against said horse pen bar system 100.

Additionally, the threading of said threaded shaft 106 is lubricated with a molybdenum disulfide-based lubricant, ensuring smooth operation, reducing wear, and preventing dirt accumulation.

In the embodiment, each among said two threaded assemblies 104 can comprise the threaded shaft 106, the swivel flange nut 108, and an engagement element 112.

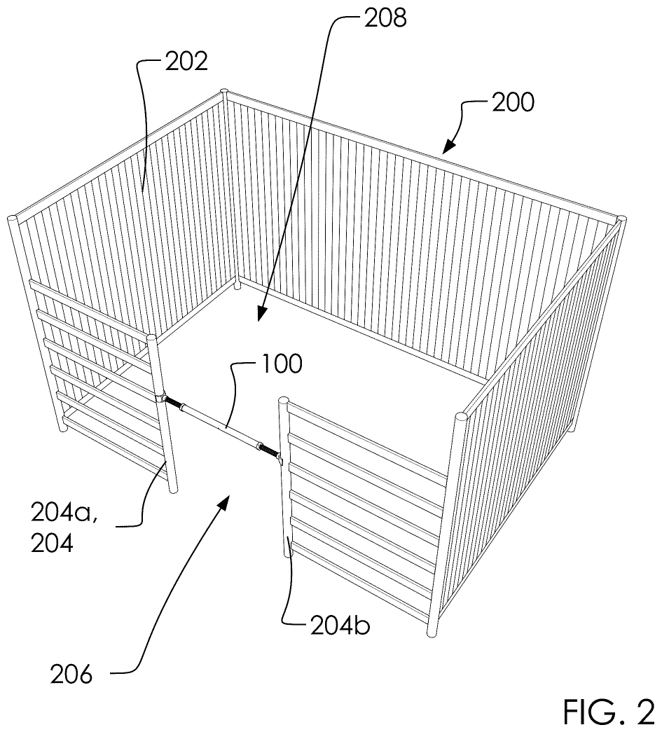

FIG. 2 illustrates a perspective view of a horse pen 200, including an entrance 206, an enclosed space 208, and the installed horse pen bar system 100.

As is known in the art, said horse pen 200 is a secure environment for housing horses while maintaining flexibility in installation.

In the embodiment shown, said entrance 206 defines the open area between two vertical supports 204. Said two vertical supports 204 comprise a first vertical support 204a and a second vertical support 204b, positioned on opposing sides of said entrance 206. Said two vertical supports 204 provide structural reinforcement and can serve as the mounting points for said horse pen bar system 100.

Said horse pen bar system 100 spans the width of said entrance 206, securely connecting said first vertical support 204a and said second vertical support 204b. This configuration reinforces said entrance 206 and ensures that said horse pen bar system 100 is securely installed.

Additionally, a pen walls 202 enclose said enclosed space 208, creating a safe and confined area for the horse.

In one embodiment, said pen walls 202 can comprise solid walls, and said two vertical supports 204 can represent portions of said pen walls 202. In such configurations, said horse pen bar system 100 spans said entrance 206 between portions of said pen walls 202, allowing for a secure and adaptable installation within enclosed or semi-enclosed environments.

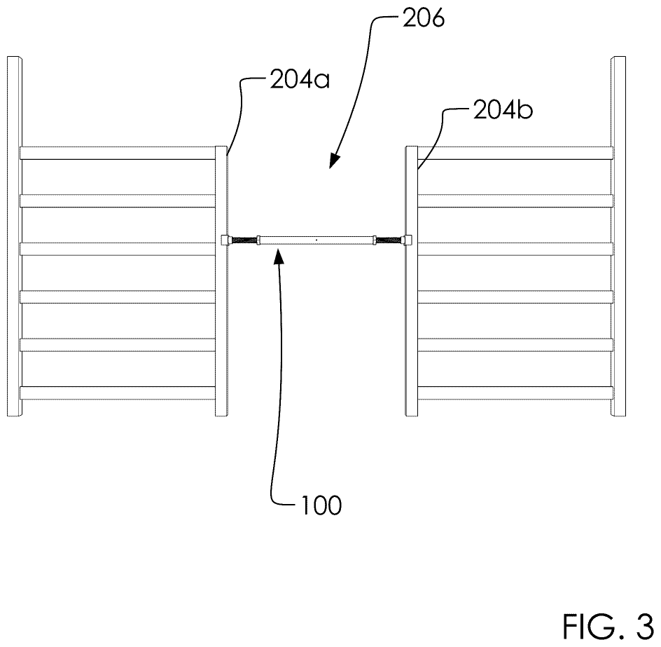

FIG. 3 introduces a detailed view of the structural relationship between the components of said horse pen bar system 100 and the surrounding environment, offering additional clarity on its installed configuration.

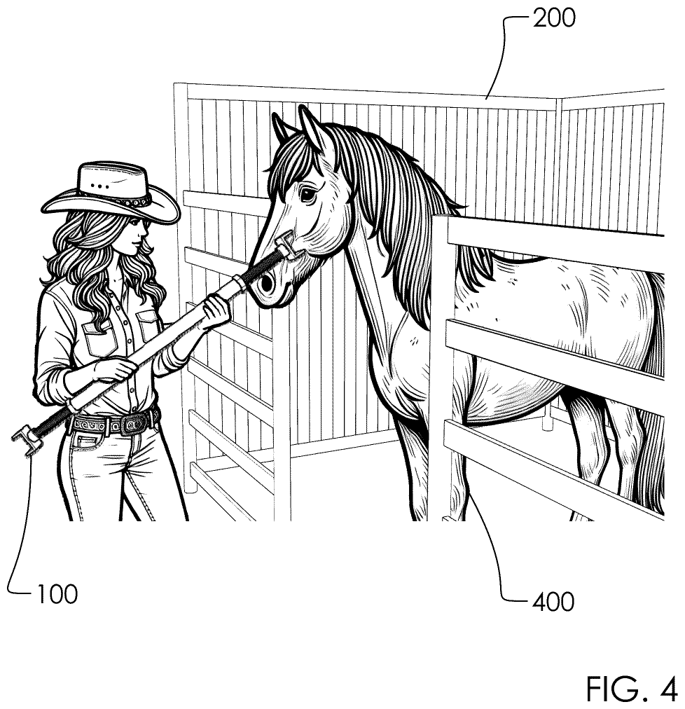

FIG. 4 illustrates a perspective view of the horse pen bar system 100 in use within the horse pen 200, highlighting the interaction between said horse pen bar system 100 and a horse 400.

This figure emphasizes the practicality and safety of said horse pen bar system 100, demonstrating how it allows for secure containment while maintaining an open and visible environment for the horse. Additionally, the design of said horse pen bar system 100 ensures ease of use, portability, and durability, making it suitable for a wide variety of settings. This figure also illustrates how the system allows individuals to safely interact with the horse, demonstrating its user-friendly design and secure containment capabilities. The system's open design not only ensures visibility for the horse but also fosters a sense of comfort by minimizing feelings of confinement.

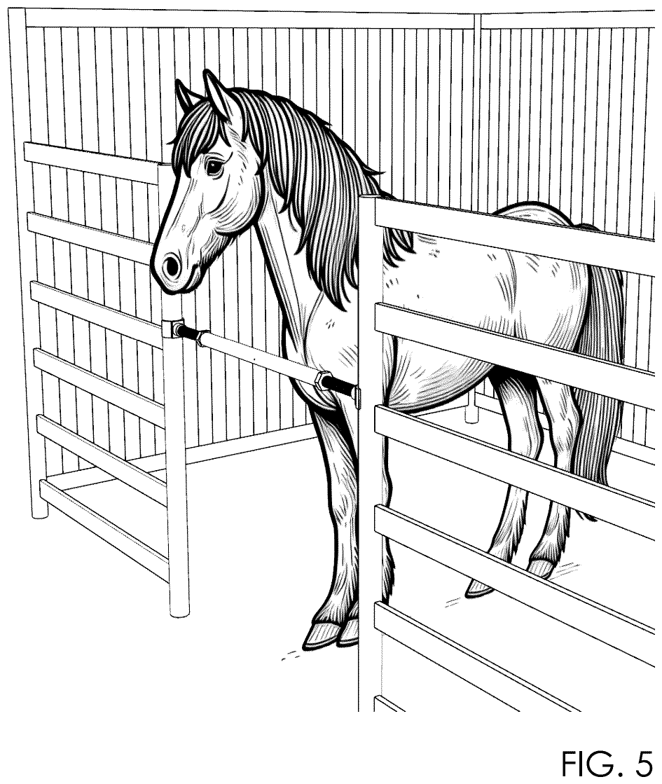

FIG. 5 illustrates an alternate perspective of said horse pen 200, focusing on the placement of said horse pen bar system 100 relative to its installed environment.

In one embodiment, said horse pen bar system 100 contributes to an open environment for the horse's comfort and visibility. By minimizing visual obstructions and maintaining an open environment, said horse pen bar system 100 fosters a sense of ease and reduces feelings of confinement for the horse, enhancing its psychological well-being.

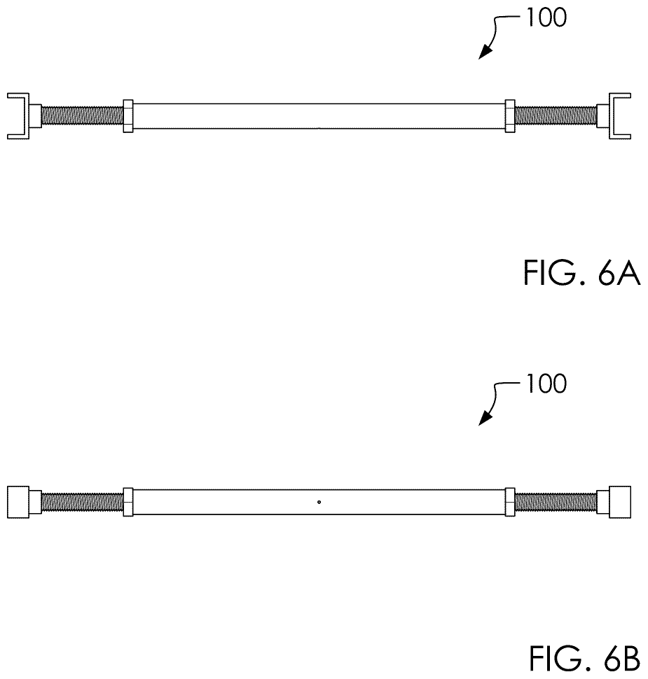

FIGS. 6A and 6B provide an elevated top view and a side view, respectively, of said horse pen bar system 100.

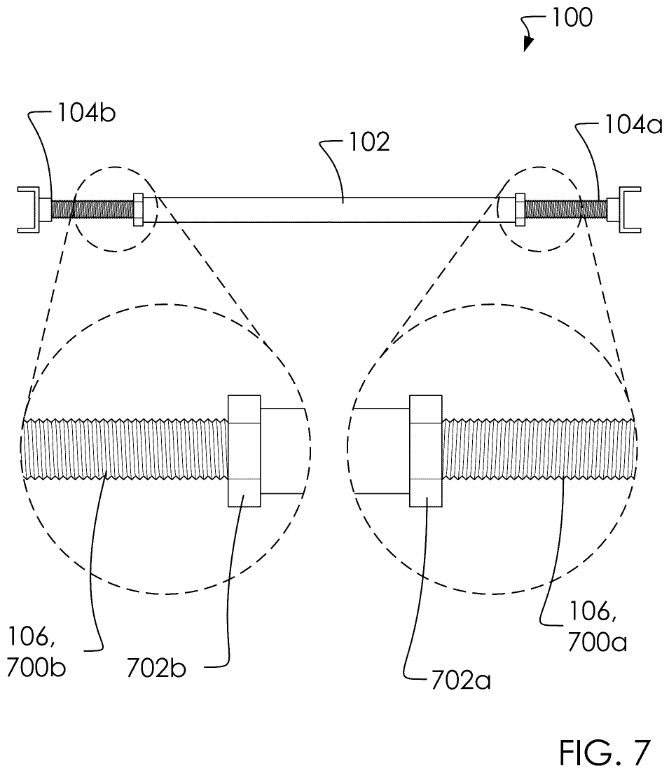

FIG. 7 provides a detailed view of the threading configurations of said horse pen bar system 100, including the first threaded assembly 104a and the second threaded assembly 104b.

In one embodiment, said two threaded assemblies 104 each comprise the threaded shaft 106 featuring a first threading orientation 700a and a second threading orientation 700b.

In one embodiment, said first threading orientation 700a and said second threading orientation 700b can be opposite one another. These opposing threading orientations allow for simultaneous expansion or contraction of said horse pen bar system 100, ensuring secure and precise adjustments between mounting points. This configuration demonstrates the adaptability and stability of said horse pen bar system 100 in various installations.

At either end of said main support bar 102, a first internal threaded receptacle 702a and a second internal threaded receptacle 702b are integrated. Said first internal threaded receptacle 702a comprises threading matching said first threading orientation 700a of said first threaded assembly 104a. Similarly, said second internal threaded receptacle 702b comprises threading matching said second threading orientation 700b of said second threaded assembly 104b. These internal threaded receptacles allow for secure engagement and smooth operation of said two threaded assemblies 104, ensuring precise and reliable adjustability of said horse pen bar system 100.

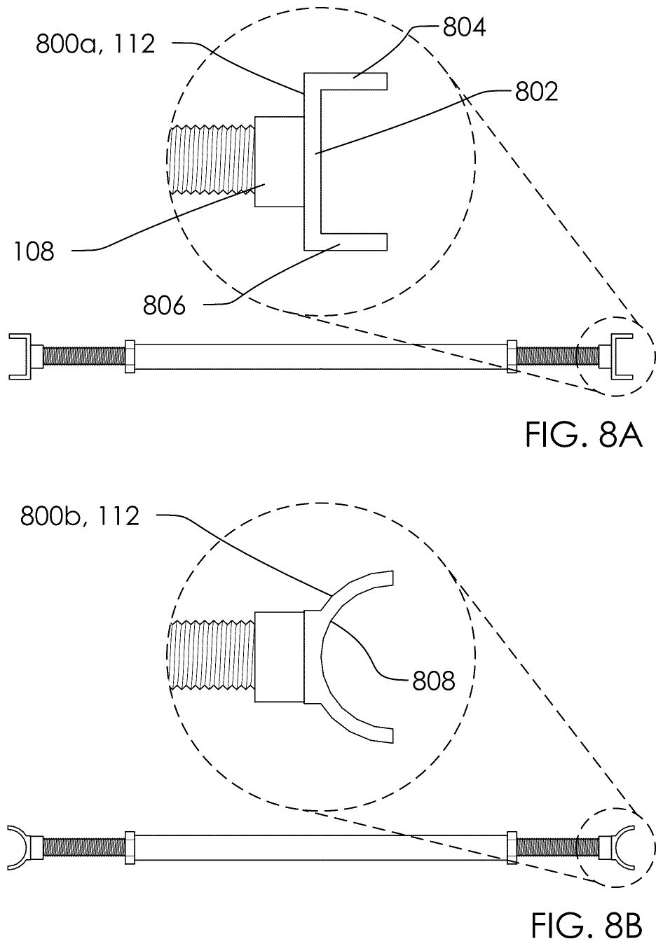

FIGS. 8A and 8B illustrate two elevated top views of said horse pen bar system 100 with two configurations of said engagement element 112.

In one embodiment, said engagement element 112 can comprise a square configuration 800a and a round configuration 800b. Wherein, square configuration 800a and round configuration 800b can be adapted to pressing firmly against two vertical supports 204 with round posts and square posts, respectively.

In one embodiment, square configuration 800a comprises a “C” shaped interface having a back portion 802, a first side portion 804 and second side portion 806. Wherein, said back portion 802 is attached to said swivel flange nut 108 and both said first side portion 804 and said second side portion 806 extend outward and substantially perpendicular to said back portion 802. Further wherein, installing said horse pen bar system 100 in said entrance 206 comprises pressing said back portion 802 into a portion of one among said two vertical supports 204, and encompassing a portion thereof with said first side portion 804 and said second side portion 806.

In one embodiment, said round configuration 800b of said engagement element 112 can comprise a half pipe shape. Wherein, said engagement element 112 comprises a rounded inner face 808.

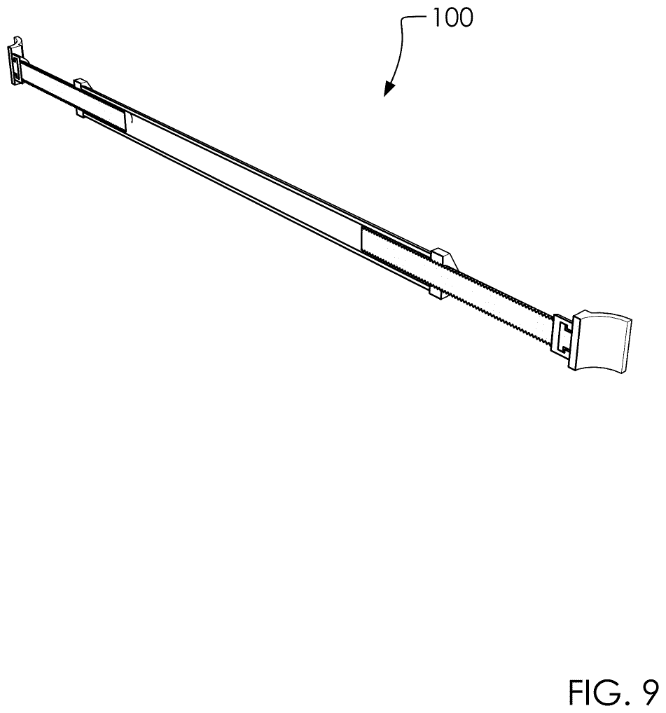

FIG. 9 illustrates a cross-section perspective overview of horse pen bar system 100.

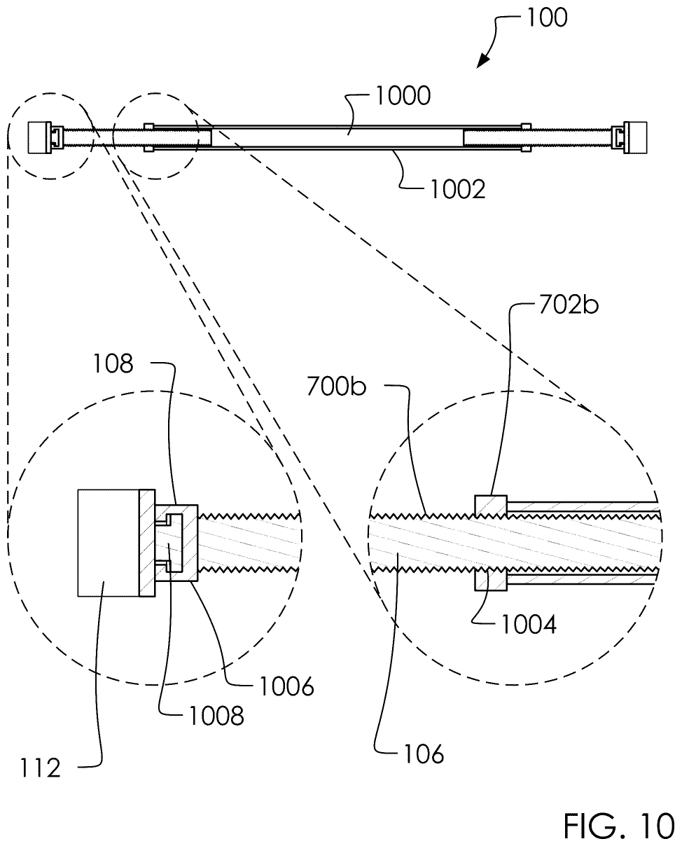

FIG. 10 illustrates a cross-section elevated front view of horse pen bar system 100.

In one embodiment, said main support bar 102 can comprise a tube interior 1000 and a tube body 1002. Wherein, said two threaded assemblies 104 are configured to rotateably enter and exit said tube interior 1000 by rotating either said main support bar 102 or said threaded shaft 106.

As discussed earlier, said first internal threaded receptacle 702a and said second internal threaded receptacle 702b can comprise said first threading orientation 700a and said second threading orientation 700b. As illustrated, second internal threaded receptacle 702b and threaded shaft 106 can interact at a threading interface 1004.

In one embodiment, swivel flange nut 108 can comprise a base portion 1006 and a socket portion 1008; wherein, swivel flange nut 108 is configured to rotate relative to threaded shaft 106 by securing engagement element 112 to socket portion 1008, securing a portion of said threaded shaft 106 to base portion 1006, and allowing base portion 1006 and socket portion 1008 to rotate relative to one another.

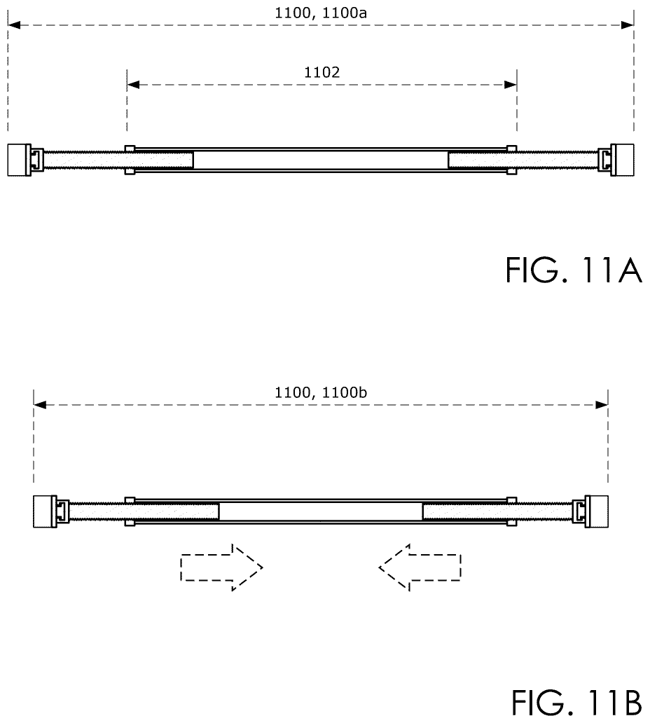

FIGS. 11A and 11B illustrate two cross-section elevated front views of horse pen bar system 100 in an extended configuration 1100a and a contracted configuration 1100b.

In one embodiment, by rotating main support bar 102 while holding a portion of two threaded assemblies 104 secure, said two threaded assemblies 104 will extend into or out of main support bar 102 causing a system width 1100 of horse pen bar system 100 to transition between said extended configuration 1100a and said contracted configuration 1100b.

In one embodiment, said main support bar 102 can comprise a length 1102 which can comprise 36″-40″ and optimally 40 inches.

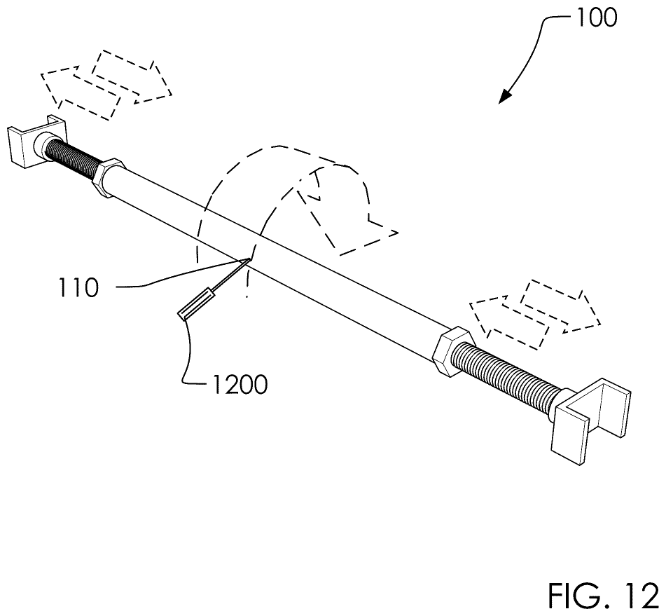

FIG. 12 illustrates a perspective overview of horse pen bar system 100 with the torque tool 1200.

In one embodiment, said torque tool 1200 can comprise a screwdriver or other implement for turning said main support bar 102 relative to said two threaded assemblies 104.

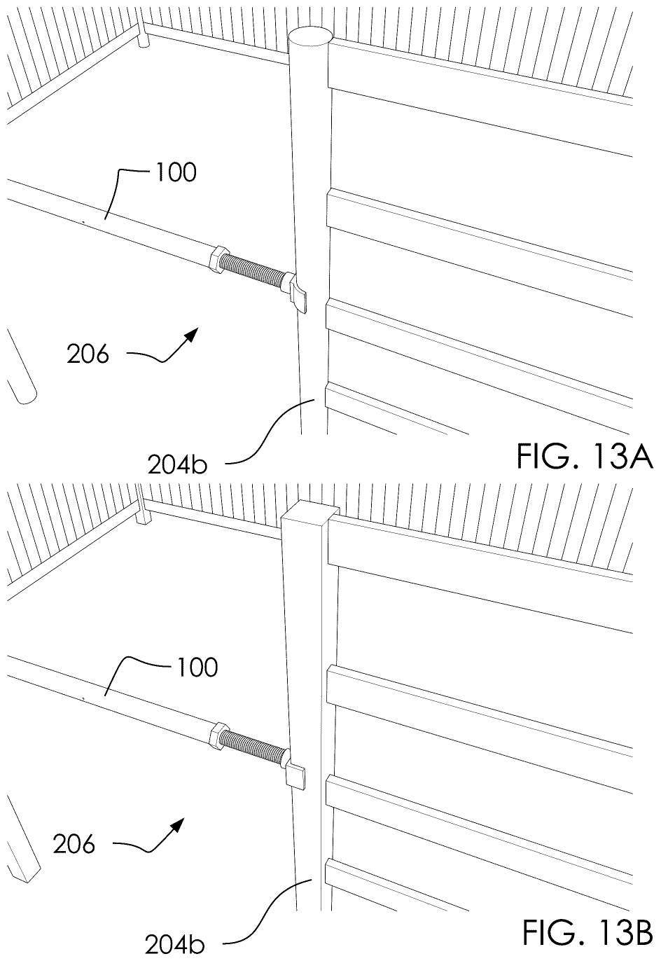

FIGS. 13A and 13B illustrate said horse pen bar system 100 interacting with a round post 1300a and a square post 1300b.

In one embodiment, said two vertical supports 204 can comprise either round post 1300a or said square post 1300b; wherein said square configuration 800a and said round configuration 800b are suitable for interfacing with said two vertical supports 204.

Preferred embodiment based on the original claims:

The horse pen bar system 100, configured for installation within the entrance 206 of the horse pen 200 for containing the horse 400 and improving the psychological well-being of the horse 400. Wherein: said horse pen bar system 100 comprises the main support bar 102 and two threaded assemblies 104. Said main support bar 102 extends longitudinally between said two threaded assemblies 104. Said two threaded assemblies 104 comprises the first threaded assembly 104a and the second threaded assembly 104b. Said two threaded assemblies 104 can be positioned at opposing ends of main support bar 102. Each of said two threaded assemblies 104 includes the threaded shaft 106 and the engagement element 112. Said entrance 206 defines the open area between two vertical supports 204. Said two vertical supports 204 comprise the first vertical support 204a and the second vertical support 204b, positioned on opposing sides of said entrance 206. Said threaded shaft 106 enables length adjustment through rotational movement, allowing the horse pen bar system 100 to fit securely within said entrance 206. Said two threaded assemblies 104 each comprise the threaded shaft 106 featuring the first threading orientation 700a and the second threading orientation 700b. Said first threading orientation 700a and said second threading orientation 700b can be opposite one another. These opposing threading orientations allow for simultaneous expansion or contraction of said horse pen bar system 100, ensuring secure and precise adjustments between mounting points. At either end of said main support bar 102, the first internal threaded receptacle 702a and the second internal threaded receptacle 702b can be integrated. Said first internal threaded receptacle 702a comprises threading matching said first threading orientation 700a of said first threaded assembly 104a. Said second internal threaded receptacle 702b comprises threading matching said second threading orientation 700b of said second threaded assembly 104b. By rotating main support bar 102 while holding a portion of two threaded assemblies 104 secure, said two threaded assemblies 104 will extend into or out of main support bar 102 causing the system width 1100 of horse pen bar system 100 to transition between the extended configuration 1100a and the contracted configuration 1100b.

Said main support bar 102 can be tubular and fabricated from 14-gauge tubing.

The main support bar 102 further comprises a centrally positioned torque aperture 110. Said torque aperture 110 can be configured to receive the torque tool 1200 enabling the user to apply additional leverage when twisting said main support bar 102.

Said main support bar 102 comprises rounded edges and smooth finishes to minimize injury risks to horses during use, particularly in environments where horses may apply pressure to or rub against the horse pen bar system 100.

The threading of the threaded shaft 106 can be lubricated with a molybdenum disulfide-based lubricant, ensuring smooth operation, reducing wear, and preventing dirt accumulation.

Said main support bar 102 comprises the tube interior 1000 and the tube body 1002. Said two threaded assemblies 104 can be configured to rotateably enter and exit said tube interior 1000 by rotating either said main support bar 102 or said threaded shaft 106.

Each of said two threaded assemblies 104 includes the threaded shaft 106 and the swivel flange nut 108.

The swivel flange nut 108 can be designed to securely engage with the threaded shaft 106, offering stability while accommodating slight angular misalignments during installation.

Said swivel flange nut 108 comprises the base portion 1006 and the socket portion 1008. Said swivel flange nut 108 can be configured to rotate relative to threaded shaft 106 by securing engagement element 112 to socket portion 1008, securing a portion of said threaded shaft 106 to base portion 1006, and allowing base portion 1006 and socket portion 1008 to rotate relative to one another.

Said engagement element 112 comprises the square configuration 800a. Said square configuration 800a comprises a “C” shaped interface having the back portion 802, the first side portion 804 and second side portion 806. Said back portion 802 can be attached to the swivel flange nut 108 and both said first side portion 804 and said second side portion 806 extend outward and substantially perpendicular to said back portion 802. Installing said horse pen bar system 100 in said entrance 206 comprises pressing said back portion 802 into a portion of one among said two vertical supports 204, and encompassing a portion thereof with said first side portion 804 and said second side portion 806.

Said engagement element 112 comprises the round configuration 800b. Said square configuration 800a and round configuration 800b can be adapted to pressing firmly against two vertical supports 204 with round posts. Said round configuration 800b of said engagement element 112 comprises a half pipe shape. Said engagement element 112 comprises the rounded inner face 808.

The horse pen bar system 100, configured for installation within the entrance 206 of the horse pen 200 for containing the horse 400 and improving the psychological well-being of the horse 400. Wherein: said horse pen bar system 100 comprises the main support bar 102 and two threaded assemblies 104. Said main support bar 102 extends longitudinally between said two threaded assemblies 104. Said two threaded assemblies 104 comprises the first threaded assembly 104a and the second threaded assembly 104b. Said two threaded assemblies 104 can be positioned at opposing ends of main support bar 102. Each of said two threaded assemblies 104 includes the threaded shaft 106 and the engagement element 112. Said entrance 206 defines the open area between two vertical supports 204. Said two vertical supports 204 comprise the first vertical support 204a and the second vertical support 204b, positioned on opposing sides of said entrance 206. Said threaded shaft 106 enables length adjustment through rotational movement, allowing the horse pen bar system 100 to fit securely within said entrance 206. Said two threaded assemblies 104 each comprise the threaded shaft 106 featuring the first threading orientation 700a and the second threading orientation 700b. Said first threading orientation 700a and said second threading orientation 700b can be opposite one another. These opposing threading orientations allow for simultaneous expansion or contraction of said horse pen bar system 100, ensuring secure and precise adjustments between mounting points. At either end of said main support bar 102, the first internal threaded receptacle 702a and the second internal threaded receptacle 702b can be integrated. Said first internal threaded receptacle 702a comprises threading matching said first threading orientation 700a of said first threaded assembly 104a. Said second internal threaded receptacle 702b comprises threading matching said second threading orientation 700b of said second threaded assembly 104b. By rotating main support bar 102 while holding a portion of two threaded assemblies 104 secure, said two threaded assemblies 104 will extend into or out of main support bar 102 causing the system width 1100 of horse pen bar system 100 to transition between the extended configuration 1100a and the contracted configuration 1100b. Said main support bar 102 comprises rounded edges and smooth finishes to minimize injury risks to horses during use, particularly in environments where horses may apply pressure to or rub against the horse pen bar system 100. Said main support bar 102 comprises the tube interior 1000 and the tube body 1002. Said two threaded assemblies 104 can be configured to rotateably enter and exit said tube interior 1000 by rotating either said main support bar 102 or said threaded shaft 106.

Said main support bar 102 comprises rounded edges and smooth finishes to minimize injury risks to horses during use, particularly in environments where horses may apply pressure to or rub against the horse pen bar system 100.

The threading of the threaded shaft 106 can be lubricated with a molybdenum disulfide-based lubricant, ensuring smooth operation, reducing wear, and preventing dirt accumulation.

The horse pen bar system 100, configured for installation within the entrance 206 of the horse pen 200 for containing the horse 400 and improving the psychological well-being of the horse 400. Wherein: said horse pen bar system 100 comprises the main support bar 102 and two threaded assemblies 104. Said main support bar 102 extends longitudinally between said two threaded assemblies 104. Said two threaded assemblies 104 comprises the first threaded assembly 104a and the second threaded assembly 104b. Said two threaded assemblies 104 can be positioned at opposing ends of main support bar 102. Each of said two threaded assemblies 104 includes the threaded shaft 106 and the engagement element 112. Said entrance 206 defines the open area between two vertical supports 204. Said two vertical supports 204 comprise the first vertical support 204a and the second vertical support 204b, positioned on opposing sides of said entrance 206. Said threaded shaft 106 enables length adjustment through rotational movement, allowing the horse pen bar system 100 to fit securely within said entrance 206. Said two threaded assemblies 104 each comprise the threaded shaft 106 featuring the first threading orientation 700a and the second threading orientation 700b. Said first threading orientation 700a and said second threading orientation 700b can be opposite one another. These opposing threading orientations allow for simultaneous expansion or contraction of said horse pen bar system 100, ensuring secure and precise adjustments between mounting points. At either end of said main support bar 102, the first internal threaded receptacle 702a and the second internal threaded receptacle 702b can be integrated. Said first internal threaded receptacle 702a comprises threading matching said first threading orientation 700a of said first threaded assembly 104a. Said second internal threaded receptacle 702b comprises threading matching said second threading orientation 700b of said second threaded assembly 104b. By rotating main support bar 102 while holding a portion of two threaded assemblies 104 secure, said two threaded assemblies 104 will extend into or out of main support bar 102 causing the system width 1100 of horse pen bar system 100 to transition between the extended configuration 1100a and the contracted configuration 1100b. Each of said two threaded assemblies 104 includes the threaded shaft 106 and the swivel flange nut 108. Said swivel flange nut 108 comprises the base portion 1006 and the socket portion 1008. Said swivel flange nut 108 can be configured to rotate relative to threaded shaft 106 by securing engagement element 112 to socket portion 1008, securing a portion of said threaded shaft 106 to base portion 1006, and allowing base portion 1006 and socket portion 1008 to rotate relative to one another.

Said engagement element 112 comprises the square configuration 800a. Said square configuration 800a comprises a “C” shaped interface having the back portion 802, the first side portion 804 and second side portion 806. Said back portion 802 can be attached to said swivel flange nut 108 and both said first side portion 804 and said second side portion 806 extend outward and substantially perpendicular to said back portion 802. Installing said horse pen bar system 100 in said entrance 206 comprises pressing said back portion 802 into a portion of one among said two vertical supports 204, and encompassing a portion thereof with said first side portion 804 and said second side portion 806.

Said engagement element 112 comprises the round configuration 800b. Said square configuration 800a and round configuration 800b can be adapted to pressing firmly against two vertical supports 204 with round posts. Said round configuration 800b of said engagement element 112 comprises a half pipe shape. Said engagement element 112 comprises the rounded inner face 808.

### PARTS LIST

said horse pen bar system 100,
said main support bar 102,
said second threaded assembly 104b,
said first threaded assembly 104a,
said two threaded assemblies 104,
said threaded shaft 106,
said swivel flange nut 108,
said torque aperture 110,
said engagement element 112,
said horse pen 200,
said pen walls 202,
said two vertical supports 204,
said first vertical support 204a,
said second vertical support 204b,
said entrance 206,
said enclosed space 208,
said horse 400,
said second threading orientation 700b,
said first threading orientation 700a,
said first internal threaded receptacle 702a,
said second internal threaded receptacle 702b,
said round configuration 800b,
said square configuration 800a,
said back portion 802,
said first side portion 804,
said second side portion 806,
said rounded inner face 808,
said tube interior 1000,
said tube body 1002,
said threading interface 1004,
said base portion 1006,
said socket portion 1008,
said contracted configuration 1100b,
said extended configuration 1100a,
said system width 1100,
said torque tool 1200,
said square post 1300b, and
said round post 1300a

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A horse pen bar system, configured for installation within an entrance of a horse pen for containing a horse and improving the psychological well-being of the horse; wherein:
said horse pen bar system comprises a main support bar and two threaded assemblies;
said main support bar extends longitudinally between said two threaded assemblies;
said two threaded assemblies comprises a first threaded assembly and a second threaded assembly;
said two threaded assemblies are positioned at opposing ends of main support bar;
each of said two threaded assemblies includes a threaded shaft and an engagement element;
said entrance defines the open area between two vertical supports;
said two vertical supports comprise a first vertical support and a second vertical support, positioned on opposing sides of said entrance;
said threaded shaft enables length adjustment through rotational movement, allowing the horse pen bar system to fit securely within said entrance;
said two threaded assemblies each comprise the threaded shaft featuring a first threading orientation and a second threading orientation;
said first threading orientation and said second threading orientation are opposite one another;
these opposing threading orientations allow for simultaneous expansion or contraction of said horse pen bar system, ensuring secure and precise adjustments between mounting points;
at either end of said main support bar, a first internal threaded receptacle and a second internal threaded receptacle are integrated;
said first internal threaded receptacle comprises threading matching said first threading orientation of said first threaded assembly;
said second internal threaded receptacle comprises threading matching said second threading orientation of said second threaded assembly; and
by rotating main support bar while holding a portion of two threaded assemblies secure, said two threaded assemblies will extend into or out of main support bar causing a system width of horse pen bar system to transition between an extended configuration and a contracted configuration.

2. The horse pen bar system of claim 1, wherein:
said main support bar is tubular and fabricated from 14-gauge tubing.

3. The horse pen bar system of claim 1, wherein:
The main support bar further comprises a centrally positioned torque aperture; and
said torque aperture is configured to receive a torque tool enabling the user to apply additional leverage when twisting said main support bar.

4. The horse pen bar system of claim 1, wherein:
said main support bar comprises rounded edges and smooth finishes to minimize injury risks to horses during use, particularly in environments where horses may apply pressure to or rub against the horse pen bar system.

5. The horse pen bar system of claim 1, wherein:
the threading of the threaded shaft is lubricated with a molybdenum disulfide-based lubricant, ensuring smooth operation, reducing wear, and preventing dirt accumulation.

6. The horse pen bar system of claim 1, wherein:
said main support bar comprises a tube interior and a tube body; and
said two threaded assemblies are configured to rotateably enter and exit said tube interior by rotating either said main support bar or said threaded shaft.

7. The horse pen bar system of claim 1, wherein:
each of said two threaded assemblies includes the threaded shaft and a swivel flange nut.

8. The horse pen bar system of claim 7, wherein:
The swivel flange nut is designed to securely engage with the threaded shaft, offering stability while accommodating slight angular misalignments during installation.

9. The horse pen bar system of claim 7, wherein:
said swivel flange nut comprises a base portion and a socket portion; and
said swivel flange nut is configured to rotate relative to threaded shaft by
securing engagement element to socket portion,
securing a portion of said threaded shaft to base portion, and
allowing base portion and socket portion to rotate relative to one another.

10. The horse pen bar system of claim 1, wherein:
said engagement element comprises a square configuration;
said square configuration comprises a “C” shaped interface having a back portion, a first side portion and second side portion;
said back portion is attached to a swivel flange nut and both said first side portion and said second side portion extend outward and substantially perpendicular to said back portion; and
installing said horse pen bar system in said entrance comprises
pressing said back portion into a portion of one among said two vertical supports, and
encompassing a portion thereof with said first side portion and said second side portion.

11. The horse pen bar system of claim 1, wherein:
said engagement element comprises a round configuration;
said square configuration and round configuration is adapted to pressing firmly against two vertical supports with round posts;
said round configuration of said engagement element comprises a half pipe shape; and
said engagement element comprises a rounded inner face.

12. The horse pen bar system of claim 1, wherein:
said main support bar comprises a length which is 40 inches.

13. A horse pen bar system, configured for installation within an entrance of a horse pen for containing a horse and improving the psychological well-being of the horse; wherein:
said horse pen bar system comprises a main support bar and two threaded assemblies;
said main support bar extends longitudinally between said two threaded assemblies;
said two threaded assemblies comprises a first threaded assembly and a second threaded assembly;
said two threaded assemblies are positioned at opposing ends of main support bar;
each of said two threaded assemblies includes a threaded shaft and an engagement element;
said entrance defines the open area between two vertical supports;
said two vertical supports comprise a first vertical support and a second vertical support, positioned on opposing sides of said entrance;
said threaded shaft enables length adjustment through rotational movement, allowing the horse pen bar system to fit securely within said entrance;
said two threaded assemblies each comprise the threaded shaft featuring a first threading orientation and a second threading orientation;
said first threading orientation and said second threading orientation are opposite one another;
these opposing threading orientations allow for simultaneous expansion or contraction of said horse pen bar system, ensuring secure and precise adjustments between mounting points;
at either end of said main support bar, a first internal threaded receptacle and a second internal threaded receptacle are integrated;
said first internal threaded receptacle comprises threading matching said first threading orientation of said first threaded assembly;
said second internal threaded receptacle comprises threading matching said second threading orientation of said second threaded assembly;
by rotating main support bar while holding a portion of two threaded assemblies secure, said two threaded assemblies will extend into or out of main support bar causing a system width of horse pen bar system to transition between an extended configuration and a contracted configuration;
said main support bar comprises rounded edges and smooth finishes to minimize injury risks to horses during use, particularly in environments where horses may apply pressure to or rub against the horse pen bar system;
said main support bar comprises a tube interior and a tube body; and
said two threaded assemblies are configured to rotateably enter and exit said tube interior by rotating either said main support bar or said threaded shaft.

14. The horse pen bar system of claim 12, wherein:
said main support bar comprises rounded edges and smooth finishes to minimize injury risks to horses during use, particularly in environments where horses may apply pressure to or rub against the horse pen bar system.

15. The horse pen bar system of claim 12, wherein:
the threading of the threaded shaft is lubricated with a molybdenum disulfide-based lubricant, ensuring smooth operation, reducing wear, and preventing dirt accumulation.

16. A horse pen bar system, configured for installation within an entrance of a horse pen for containing a horse and improving the psychological well-being of the horse; wherein:
said horse pen bar system comprises a main support bar and two threaded assemblies;
said main support bar extends longitudinally between said two threaded assemblies;
said two threaded assemblies comprises a first threaded assembly and a second threaded assembly;
said two threaded assemblies are positioned at opposing ends of main support bar;
each of said two threaded assemblies includes a threaded shaft and an engagement element;
said entrance defines the open area between two vertical supports;
said two vertical supports comprise a first vertical support and a second vertical support, positioned on opposing sides of said entrance;
said threaded shaft enables length adjustment through rotational movement, allowing the horse pen bar system to fit securely within said entrance;
said two threaded assemblies each comprise the threaded shaft featuring a first threading orientation and a second threading orientation;
said first threading orientation and said second threading orientation are opposite one another;
these opposing threading orientations allow for simultaneous expansion or contraction of said horse pen bar system, ensuring secure and precise adjustments between mounting points;
at either end of said main support bar, a first internal threaded receptacle and a second internal threaded receptacle are integrated;
said first internal threaded receptacle comprises threading matching said first threading orientation of said first threaded assembly;
said second internal threaded receptacle comprises threading matching said second threading orientation of said second threaded assembly;
by rotating main support bar while holding a portion of two threaded assemblies secure, said two threaded assemblies will extend into or out of main support bar causing a system width of horse pen bar system to transition between an extended configuration and a contracted configuration;
each of said two threaded assemblies includes the threaded shaft and a swivel flange nut;
said swivel flange nut comprises a base portion and a socket portion; and
said swivel flange nut is configured to rotate relative to threaded shaft by
securing engagement element to socket portion,
securing a portion of said threaded shaft to base portion, and
allowing base portion and socket portion to rotate relative to one another.

17. The horse pen bar system of claim 16, wherein:
said engagement element comprises a square configuration;
said square configuration comprises a “C” shaped interface having a back portion, a first side portion and second side portion;
said back portion is attached to said swivel flange nut and both said first side portion and said second side portion extend outward and substantially perpendicular to said back portion;
installing said horse pen bar system in said entrance comprises
pressing said back portion into a portion of one among said two vertical supports, and
encompassing a portion thereof with said first side portion and said second side portion.

18. The horse pen bar system of claim 16, wherein:
said engagement element comprises a round configuration;
said square configuration and round configuration is adapted to pressing firmly against two vertical supports with round posts;
said round configuration of said engagement element comprises a half pipe shape; and
said engagement element comprises a rounded inner face.
